(19) United States
(12) Patent Application Publication
(10) Pub. No.: US 2009/0315939 A1
(43) Pub. Date: Dec. 24, 2009

(54) System And Method For Defective Inkjet Correction Using Edge Information In An Image

(75) Inventors: David Allen Mantell, Rochester, NY (US); Stephen Michael Kroon, Sherwood, OR (US)

Correspondence Address: MAGINOT, MOORE & BECK LLP, 111 MONUMENT CIRCLE, SUITE 3250, INDIANAPOLIS, IN, 46204, US

(73) Assignee: XEROX CORPORATION, Norwalk, CT (US)

(21) Appl. No.: 12/145,049

(22) Filed: Jun. 24, 2008

(51) Int. Cl. B41J 29/393

(52) U.S. Cl. 347/19

(57) ABSTRACT

A method for image correction compensates for a defective inkjet in a printhead by distributing compensation values to other image data locations in an image data memory. The method includes searching image data stored in an image data array to detect one or more edges in the image data, modifying an ordered sequence search to search for compensation candidate positions in image data array positions proximate a defective inkjet image data array position in response to an edge being detected proximate to the defective inkjet image data array position, searching the image data array positions proximate the defective inkjet image data array position in accordance with the modified ordered sequence, identifying a compensation candidate image data array position to which a compensation image value can be moved, and moving the compensation image value to the identified compensation candidate image data array position.

### TECHNICAL FIELD

This disclosure relates generally to imaging devices that eject ink from inkjets onto an image substrate and, more particularly, to imaging devices that detect inkjets in a printhead that are unable to eject ink to form a pixel on an image receiving member.

### BACKGROUND

Drop on demand inkjet technology for producing printed media has been employed in commercial products such as printers, plotters, and facsimile machines. Generally, an inkjet image is formed by selectively ejecting ink drops from a plurality of drop generators or inkjets, which are arranged in a printhead or a printhead assembly, onto an image substrate. For example, the printhead assembly and the image substrate are moved relative to one other and the inkjets are controlled to emit ink drops at appropriate times. The timing of the inkjet activation is performed by a printhead controller, which generates firing signals that activate the inkjets to eject ink. The image substrate may be an intermediate image member, such as a print drum or belt, from which the ink image is later transferred to a print medium, such as paper. The image substrate may also be a moving web of print medium or sheets of a print medium onto which the ink drops are directly ejected. The ink ejected from the inkjets may be liquid ink, such as aqueous, solvent, oil based, UV curable ink or the like, which is stored in containers installed in the printer. Alternatively, the ink may be loaded in a solid form that is delivered to a melting device, which heats the solid ink to its melting temperature to generate liquid ink that is supplied to a print head.

During the operational life of these imaging devices, inkjets in one or more printheads may become unable to eject ink in response to a firing signal. The defective condition of the inkjet may be temporary and the inkjet may return to operational status after one or more image printing cycles. In other cases, the inkjet may not be able to eject ink until a purge cycle is performed. A purge cycle may successfully unclog inkjets so they are able to eject ink once again. Execution of a purge cycle, however, requires the imaging device to be taken out of its image generating mode. Thus, purge cycles affect the throughput rate of an imaging device and are preferably performed during periods in which the imaging device is not generating images.

Methods have been developed that enable an imaging device to generate images even though one or more inkjets in the imaging device are unable to eject ink. These methods cooperate with image rendering methods to control the generation of firing signals for inkjets in a printhead. Rendering refers to the processes that receive input image data values and then generate output image values. The output image values are used to generate firing signals for a printhead to cause the inkjets to eject ink onto the recording media. Once the output image values are generated, a method may use information regarding defective inkjets detected in a printhead to identify the output image values that correspond to a defective inkjet in a printhead. The method then searches to find a neighboring or nearby output image value that can be adjusted to compensate for the defective inkjet. Preferably, an increase in the amount of ink ejected near the defective inkjet may be achieved by replacing a zero or nearly zero output image value with the output image value that corresponds to the defective inkjet. Another method increases neighboring or nearby output image values to boost the amount of ink to be ejected by a plurality of inkjets in the vicinity of the defective inkjet. Another method is able to compensate for the defective inkjet because a normalization process may be used to establish a maximum output image value for inkjets that is less than the output value that causes an inkjet to eject the maximum amount of ink that can be ejected by an inkjet. Thus, an output image value can be increased beyond the normalized maximum output image value to enable an inkjet to eject an amount of ink corresponding to the maximum output value plus some incremental amount. By firing several nearby inkjets in this manner, the ejected ink density can approximate the ink mass that would have been ejected had the defective inkjet been able to eject the ink for a missing pixel.

The previously known methods for re-distributing the ink to be ejected by a defective inkjet to other neighboring or nearby inkjets are useful as long as the nearby inkjets and the defective inkjet are printing a generally uniform area. When a defective inkjet is located in or near an edge of an object, indiscriminate re-distribution may result in increased ink density in areas that are noticeably outside an object's boundaries. Particularly when the object is a textual character, such redistribution of the missing pixel may cause the textual character to have ragged edges. To attenuate this effect, the output image value adjustments may be constrained to those values that are adjacent to the value for the defective inkjet. A previously known method evaluated halftone areas and determined if a region in the vicinity of a defective inkjet was in a uniformly halftone area. If it was not in a uniformly halftone area, the compensating values were constrained accordingly. In this method, some areas that were not located at an object boundary were identified as being non-uniform halftone areas. In an error diffused or hybrid rendered image, this method identifies all regions as being non-uniform halftone regions. Consequently, defective inkjet compensation methods that enable more selective placement of the ink used to compensate for a defective inkjet may be useful.

### SUMMARY

A system compensates for a defective inkjet in a printhead by distributing compensation image values to other image data positions with reference to edges detected in the image data values around the image data position corresponding to the defective inkjet. The system includes an image data memory having a plurality of locations in which image data values are stored, and a processor configured to search the image data memory locations to detect one or more edges in the image data values and to modify a first ordered sequence search to identify compensation candidate locations proximate a defective inkjet image data array location in response to an edge being detected proximate to the defective inkjet image data array location.

A method is also disclosed that compensates for a defective inkjet in a printhead by distributing compensation image values to other image data memory locations in an image data memory. The method includes searching image data stored in an image data array to detect one or more edges in the image data, modifying an ordered sequence search to search for compensation candidate positions in image data array positions proximate a defective inkjet image data array position in response to an edge being detected proximate to the defective inkjet image data array position, searching the image data array positions proximate the defective inkjet image data array position in accordance with the modified ordered sequence, identifying a compensation candidate image data array position to which a compensation image value can be moved, and moving the compensation image value to the identified compensation candidate image data array position.

A computer readable medium is described below that enables a computer to perform a method for distributing compensation values in an image data memory. The computer readable medium contains instructions that, when executed by the computer, cause the computer to perform a method for detecting one or more edges in image data values stored in image data memory locations, and for modifying an ordered sequence search used to identify at least one image data memory location for storage of an image data compensation value in response to an edge being detected proximate to a defective inkjet image data memory location.

### BRIEF DESCRIPTION OF THE DRAWINGS

The foregoing aspects and other features of a printer that enables compensation for defective inkjet with reference to edges in images are explained in the following description, taken in connection with the accompanying drawings, wherein:

FIG. 1 is a block diagram of an inkjet printing system in which a system and method that compensate for defective inkjets may be used.

FIG. 2 is a block diagram of a system that detects edges in image data and adjusts placement of increased output image values accordingly.

FIG. 3 is an example of an extended search pattern used to detect image data positions available for defective inkjet compensation.

FIG. 4 is an example of a tight search pattern used to detect image data positions available for defective inkjet compensation.

FIG. 5 is a flow diagram of a method that detects edge in image data and adjusts placement of output image value increases accordingly.

### DETAILED DESCRIPTION

For a general understanding of the environment for the system and method disclosed herein as well as the details for the system and method, reference is made to the drawings. In the drawings, like reference numerals have been used throughout to designate like elements. As used herein, the word “printer” encompasses any apparatus that performs a print outputting function for any purpose, such as a digital copier, bookmaking machine, facsimile machine, a multi-function machine, etc.

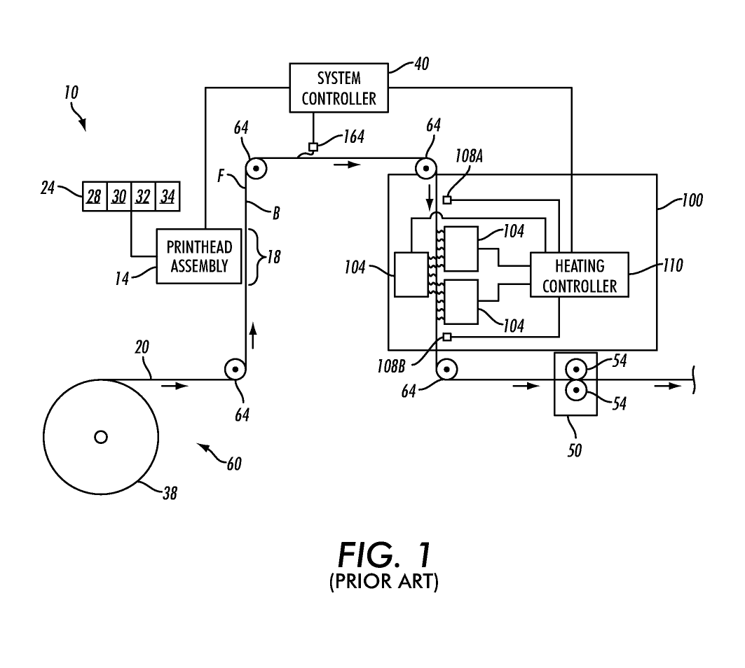

FIG. 1 depicts an imaging apparatus 10, or at least a portion of an imaging apparatus, in which elements pertinent to the present disclosure are shown. In the embodiment shown, the imaging apparatus 10 implements a solid ink print process for printing onto a continuous media web. Although the system and method disclosed herein is most beneficial in imaging systems in which the recording media passes the printheads only once, they may be used in imaging systems in which multiple passes occur to form an image. Also, while the system and method are discussed in the context of a solid ink printer, they may be used with systems that use other types of liquid ink, such as aqueous, emulsified, gel, or UV curable inks.

The imaging device 10 in FIG. 1 includes a web supply and handling system 60, a phase change ink printing system 16, and a web heating system 100. Although the image data processing system and method are described below with reference to the solid ink imaging system depicted in FIG. 1, the defective inkjet compensation system and method may be used in any imaging apparatus that provides liquid ink to the printheads, such as cartridge inkjet systems.

As shown in FIG. 1, the phase change ink printing system includes a web supply and handling system 60, a printhead assembly 14, a web heating system 100, and a fixing assembly 50. The web supply and handling system 60 may include one or more media supply rolls 38 for supplying a media web 20 to the imaging device. The supply and handling system is configured to feed the media web in a known manner along a media pathway in the imaging device through the print zone 18, past the web heating system 100, and through the fixing assembly 50. To this end, the supply and handling system 60 may include any suitable device 64, such as drive rollers, idler rollers, tensioning bars, etc., for moving the media web through the imaging device. The system may include a take-up roll (not shown) for receiving the media web 20 after printing operations have been performed. Alternatively, the media web 20 may be fed to a cutting device (not shown) as is known in the art for cutting the media web into discrete sheets.

The printhead assembly 14 is appropriately supported to eject drops of ink directly onto the media web 20 as the web moves through the print zone 18. In other imaging systems in which the defective inkjet compensation system and method may be used, the printhead assembly 14 may be configured to eject drops onto an intermediate transfer member (not shown), such as a drum or belt, for subsequent transfer to a media web or media sheets. The printhead assembly 14 may have two or more printheads. Within each printhead, a plurality of inkjets is arranged in a row and column fashion. Each of the inkjets is coupled to a source of liquid ink and each one ejects ink through an inkjet nozzle in response to a firing signal being received by an inkjet actuator, such as a piezoelectric actuator, in the inkjet.

In the illustrated system of FIG. 1, the printhead assembly includes a plurality of printheads for printing full color images comprised of the colors cyan, magenta, yellow, and black. For example, the printhead assembly 14 in FIG. 1 may have eight printheads, two for each color of ink supplied by the solid ink supply 24. Each printhead has a predetermined inkjet density, which may be, for example, 300 dots per inch (dpi). The two or more printheads for a particular color may be serially arranged, which means that some of the printheads are located downstream in the direction of web movement from the other printheads that eject the same color of ink. The downstream printheads may be offset from the upstream printheads by an integral number plus zero to one-half of the inkjet spacing on a printhead. Thus, the serially arranged printheads enable one or more rows, depending upon the number of inkjet rows in the printheads, to be printed with a density that is twice the density of each single printhead. For example, two 300 dpi printheads offset by a distance of one-half of an inkjet width enable rows of 600 dpi to be printed, though the printheads need not be aligned to an integral number plus one-half of the inkjet spacing either by intention or by misalignment.

In the printing system shown in FIG. 1, ink is supplied to the printhead assembly from a solid ink supply 24. Since the phase change ink imaging device 10 is a multicolor device, the ink supply 24 includes four sources 28, 30, 32, 34, representing four different colors CYMK (cyan, yellow, magenta, black) of phase change ink. The phase change ink system 24 also includes a solid phase change ink melting and control assembly or apparatus (not shown) for melting or phase changing the solid form of the phase change ink into a liquid form, and then supplying the liquid ink to the printhead assembly 14. Each color of ink is supplied to at least one printhead in the assembly 14. The differently colored inks are supplied through separate conduits. A single line connects the ink supply 24 with the printhead assembly 18 in the figure to simplify the representation depicted in the figure. Operation and control of the various subsystems, components, and functions of the device 10 are performed with the aid of a controller 40.

In order to form an image with the ink ejected by the printhead assembly 14, input image data are rendered into output image values that are used to generate firing signals that selectively actuate the inkjets in the printheads to eject ink onto the web as it moves past the printhead assembly. Typically, digital image data are received by the device 10. These digital image data may include an image for each color to be printed in the image. The input image data for a single color is called a color separation for the overall image. Each datum in a color separation corresponds to an input image value for a particular location in the color separation. The processing of the input image values is typically performed by a marking engine, which is controlled by a processor executing instructions stored in a memory operatively coupled to the processor.

The processor for the marking engine may be implemented with one or more processors, one of which may be configured to perform the defective inkjet compensation method described below. The processor may be a general purpose processor having an associated memory in which programmed instructions are stored. Execution of the programmed instructions enables the processor to process the input image values to detect edges and adjust output image values about the detected edges. The processor may, alternatively, be an application specific integrated circuit or a group of electronic components configured on a printed circuit. Thus, the processor may be implemented in hardware alone, software alone, or a combination of hardware and software. In one embodiment, the processor for the marking engine comprises a self-contained, microcomputer having a central processor unit (not shown) and electronic storage (not shown). The electronic storage may be a non-volatile memory, such as a read only memory (ROM) or a programmable non-volatile memory, such as an EEPROM or flash memory. The image data source may be any one of a number of different sources, such as a scanner, a digital copier, a facsimile device, etc.

Once the input image values have been used by the printhead controller to generate firing signals for the inkjets in the printheads of the printhead assembly, drops of ink are ejected onto the moving web to form an image. The web continues to move so the image passes through a fixing assembly 50, which fixes the ink drops to the web. In the embodiment of FIG. 1, the fixing assembly 50 comprises at least one pair of fixing rollers 54 that are positioned in relation to each other to form a nip through which the media web is fed. The ink drops on the media web are pressed into the web and spread out on the web by the pressure formed by the nip. Although the fixing assembly 50 is depicted as a pair of fixing rollers, the fixing assembly may be any suitable type of device or apparatus, as is known in the art, which is capable of fixing, drying, or curing an ink image onto the media.

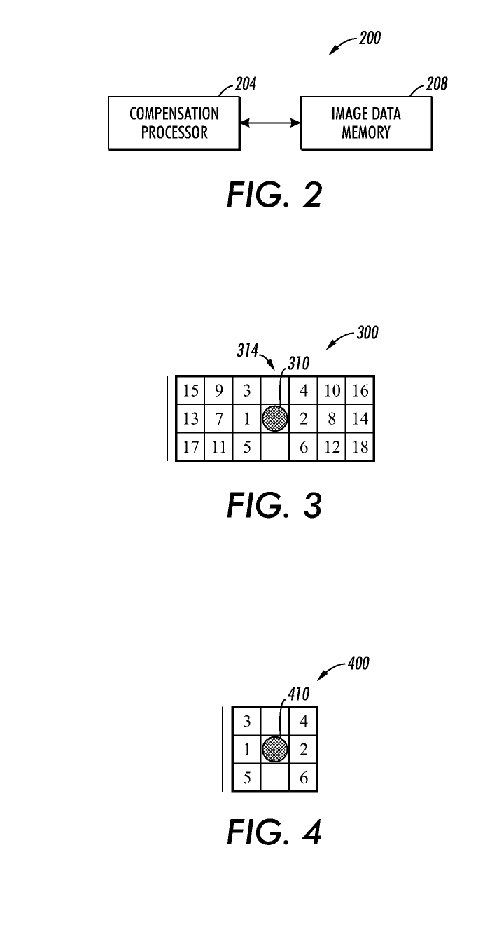

A block diagram of a system that processes output image values to compensate for defective inkjets is shown in FIG. 2. The system 200 includes an image data memory 204 in which output image values are stored. The output image values stored in the memory 204 are processed by a processor 208, which is configured to search the image data memory in an ordered sequence to detect an image data position in the memory in which a compensation image data value can be stored. Configuration of the processor refers to a combination of programming instructions, hardware components, and related circuitry that enable a task to be performed.

In the discussion presented below, edge searching is performed in the image data array positions that are proximate to an image data array position that corresponds to a defective inkjet. Edge searching, however, may also be performed by searching through all of the image data array positions to detect one or more edges in the array before defective inkjet image data array positions are identified. This type of searching may be preferred for detecting edges in the image as a whole rather than edges associated with particular features near a defective inkjet. Numerous distinguishing features may be used to detect edges within or for an image. For example, some edges transition from dark to light and/or vice versa. These transitions may occur in any of a number of directions, e.g., vertical, horizontal, or both directions. Edges may also occur in one particular color plane of a color separated image. Thus, different types of edges may be detected and classified accordingly. For example, edges may be classified according to a spatial direction (vertical, horizontal, etc.), a color plane, an intensity direction (light to dark), or a spatial direction in a color plane, to name a few possible classifications. After detecting and classifying one or more edges, the search for compensation candidate positions may be performed with reference to the type of edge detected. For one example, only image data array positions in the vicinity of edges in the same color plane as the defective jet may be searched. For another example, any image data array position on a darker edge side may be searched, but the search on the lighter side of the edge may be limited to those positions within a single pixel of the edge. In another example, the image data array positions in vertical single pixel line may be considered to be at both a light-to-dark edge and a dark-to-light edge, though this type of edge may be classified as a special type of edge with a corresponding search pattern. Generally, the search pattern for this type of edge is limited to only one side or another of the edge, rather than alternating the search between the right and left sides of the edge.

An ordered sequence search may correspond to the search pattern 300 shown in FIG. 3. As shown there, the central image data position 310 corresponds to an output image value that would be used to generate a firing signal for a defective inkjet. The image data positions above and below the position 310 define a column 314 of image data positions. The numbers in the image data positions represent the order in which the image data positions are searched. The processor configuration enables an image data position in which a compensation value can be stored to be detected. To detect such a position, the output image values in the image data positions are tested to determine whether they are at or below a threshold value. The threshold value may be zero. In response to an image data position being at or below the threshold value, a compensation value is added to the image data value in the position. The compensation value corresponds to the output image value at position 310 that would have been used to generate a firing signal for the defective inkjet. Alternatively, the compensation value may be a difference between the output image value stored in the detected position and a maximum output image value. To determine whether additional compensation is required, the differential compensation value may be subtracted from the output image value at position 310 and, if a non-zero value remains, the search continues until another image data position is detected. If no other image data position is detected, then no further compensation is available. If another image data position is detected, then a compensation value or differential compensation value is added to the detected position. The processor then adjusts the output image value at position 310 and determines whether additional compensation is required. The compensation process continues until the output image value at position 310 is either fully distributed or all of the positions in the search pattern have been tested.

The processor configuration is capable of myriad variations to enhance the detection and compensation performed by the processor. In one embodiment, the processor modifies the ordered sequence for the next ordered sequence search in an effort to distribute the compensation values more evenly. In this embodiment, the processor commences the search on the side of the column that is opposite the detected image data position. For example, if the detected image position was position 7 (FIG. 3), then the sequence pattern for the next search is modified so the odd-numbered positions are on the right side of the column 314 and the even-numbered positions are on the left side of the column 314.

In another embodiment, the processor is configured to detect edges in the output image data of the image data memory. Edge detection is well-known in the art and the known methods may be used to detect edges in the image data stored in the memory 204. Once an edge is detected, the ordered sequence is altered to use the search pattern 400 shown in FIG. 4. This search pattern is more tightly constrained about the image data position 410 that corresponds to the defective inkjet. Because edges do not necessarily benefit from alternation of the compensation values about the edge, the ordered sequence is not flipped for a next search as described above. This processing enables a single pixel line to be moved in its entirety by a one pixel and not distributed to neighbors on both sides of a line printed by the defective inkjet. In another embodiment, the processor is configured to detect uniformity in an area on one side of an edge. In response, the pattern shown in FIG. 3 may be used provided the pattern is extended beyond the positions adjacent to the defective inkjet position on the side of the edge that is uniform.

In another embodiment using the pattern discussed above, pixels are not distributed beyond an object edge or possibly distributed to a single pixel position beyond the edge that is detected within an extended region, such as the one depicted in FIG. 3, but outside another extended region, such as the one depicted in FIG. 4. In yet another embodiment, the orientation and extent of the edge is identified and the sequence pattern for the search is adjusted accordingly. For example, a single pixel may be identified as a bidirectional edge enabling a line to be treated with a pattern, such as the one shown in FIG. 3, where only the left side positions corresponding to the odd numbers are searched. Another example is treatment of a narrow two pixel wide edge. In this processing, pixels corresponding to a defective inkjet on one side of the edge are preferentially distributed to the other side of the edge to enable the edge to remain two pixels wide rather than becoming two lines separated by a single pixel.

As noted above, numerous techniques for edge detection are known and may be used. In one embodiment, the processor is configured to filter the output image values and to compare the filtered values to a threshold to detect an edge in the memory. The threshold comparison helps prevent small transitions and noise from being identified as edges. In another embodiment, the processing may be performed on rendered image data and the edges are derived from the rendered data. Edge detection techniques are well-known in the art and they may be used to detect edges in the rendered image data or in binary image data. Binary image data may be derived from image data by comparing the image data to a threshold value in a threshold array and assigning a bit value of either 1 or 0 to an image data position in response to a comparison of the image data at a storage location to the threshold value. Additionally, a detected edge may be dilated to enhance treatment of the areas about the detected edges. Enhanced treatment includes modification of the ordered sequence search at image data positions in the vicinity of the dilated edge.

In another embodiment, the rendered image data includes multiple levels corresponding to the number of ink drops per pixel. Consequently, more than one ink drop to be ejected by a defective inkjet at a pixel location may need to be moved. Drops may be moved to neighbors that already contain drops as long as the number of drops at the candidate location is less than the maximum number of drops for a pixel. In one embodiment, the search patterns may be different for different drops at a pixel location. For example, the search for candidate locations may start on one side for the first drops at a location and on the other side for the next drop at the location. In response to a detected edge, the ordered sequence search may be modified to start only one side of the detected edge.

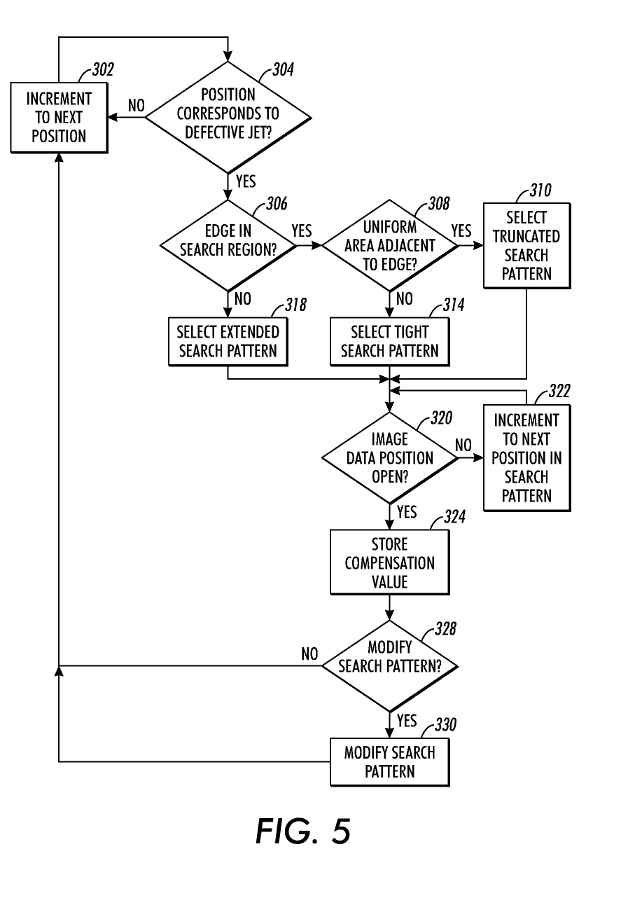

A method that may be used to compensate for output image values corresponding to defective inkjets is shown in FIG. 5. The method 300 includes searching through the memory until an image value stored in an image data position that corresponds to a defective inkjet is detected (blocks 302, 304). The image data positions about the image data position corresponding to the defective inkjet are searched for an edge (block 306). If an edge is found, the area is searched to detect whether an area adjacent the edge is uniform (block 308). If it is, a truncated search pattern is used that disables searching across the edge, but enables extended searching in the uniform area (block 310). Otherwise, a tight search pattern is used (block 314). A tight search pattern is one in which the compensation candidate positions are limited to one side of an edge. If no edge is detected, then an extended ordered sequence is used to search for a compensation candidate position to store a compensation value (block 318). Once a compensation candidate image data position is detected using the selected search pattern (blocks 320, 322), a compensation value is stored in the detected compensation candidate image data position (block 324). If a search pattern change is warranted (block 328), the change is made (block 330). For example, as noted above, the ordered sequence extends on both sides of a column in the image data memory as long as an edge is not detected in the search region. This extended ordered sequence may be modified, such as by flipping the arrangement, to distribute the compensation values more evenly. Modification of the search pattern for regions having an edge, however, is not performed. The process is applied to all areas in the image data memory that are located in a vicinity around image data positions that correspond to defective inkjets (block 302).

The method shown in FIG. 5 may be varied in other embodiments. For example, the edge search may be performed before any defective inkjet is detected. In this embodiment, the entire image data array or memory may be searched to detect one or more edges in the image data. Following edge detection and, possibly, edge classification, a search for defective inkjets may be performed In regions where a defective inkjet image data location is proximate an edge, an ordered search for compensation candidate locations may be altered as described above.

The methods disclosed herein may be implemented by a processor being configured with instructions and related circuitry to perform the methods. Additionally, processor instructions may be stored on computer readable medium so they may accessed and executed by a computer processor to perform the methods for distributing compensation image values to image data positions located around an image data position corresponding to a defective inkjet.

It will be appreciated that various of the above-disclosed and other features, and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A method for image correction to compensate for a defective inkjet in a printhead comprising:
searching image data stored in an image data array to detect one or more edges in the image data;
modifying an ordered sequence search to search for compensation candidate positions in image data array positions proximate a defective inkjet image data array position in response to an edge being detected proximate to the defective inkjet image data array position;
searching the image data array positions proximate the defective inkjet image data array position in accordance with the modified ordered sequence;
identifying a compensation candidate image data array position to which a compensation image value can be moved; and
moving the compensation image value to the identified compensation candidate image data array position.

2. The method of claim 1, the edge detection further comprising:
filtering image values in the image data array positions; and
comparing the filtered image values to a threshold to detect an edge in the image data array.

3. The method of claim 1 wherein all image data array positions in the image data array are searched to detect one or more edges before the image data array positions proximate the defective inkjet data array position are searched for compensation candidate positions.

4. The method of claim 1 wherein only the image data array positions proximate the defective inkjet are searched to detect one or more edges.

5. The method of claim 1, the searching of the image data array positions proximate the defective inkjet image data array position further comprising:
comparing an image value in an image data array position to a threshold value; and
detecting a compensation candidate position in response to the image value in the image data array position being equal to or less than the threshold value.

6. The method of claim 5 wherein the threshold value is zero.

7. The method of claim 1 further comprising:
rendering the image data in the image data array before searching for one or more edges.

8. The method of claim 7 wherein the rendered image data includes multiple levels corresponding to a number of ink drops stored in each image data array position; and
an ordered sequence search for each level is modified in response to an edge being detected proximate to the defective inkjet image data array position.

9. The method of claim 7 wherein the ordered sequence search for each level in an image array data position is different for each level.

10. The method of claim 1 further comprising:
assigning a classification to at least one of the detected edges; and
conducting the search for the compensation candidate positions in the image data array positions proximate the detected edge having an assigned classification in accordance with an ordered sequence search pattern associated with the detected edge classification.

11. A system for image correction to compensate for a defective inkjet in a printhead comprising:
an image data memory having a plurality of locations in which image data values are stored; and
a processor configured to search the image data memory locations to detect one or more edges in the image data values and to modify a first ordered sequence search to identify compensation candidate locations proximate a defective inkjet image data array location in response to an edge being detected proximate to the defective inkjet image data array location.

12. The system of claim 11 wherein the image data stored in the image data memory are rendered image data.

13. The system of claim 11, wherein the processor is configured to modify the ordered sequence search to start a search of image data memory locations on only one side of the detected edge.

14. The system of claim 11, the processor being further configured to filter image values in the image data memory locations and to compare the filtered image values to a threshold to detect an edge in the image data memory.

15. The system of claim 11 wherein all locations in the image data memory are searched to detect one or more edges before the image data memory locations proximate a defective inkjet image data memory location are searched for compensation candidate locations.

16. The method of claim 11 wherein only the image data memory locations proximate the defective inkjet image data memory location are searched to detect one or more edges.

17. The system of claim 11, the processor being configured to detect a compensation candidate location in response to an image value in an image data memory location being equal to or less than a threshold value.

18. The system of claim 17, the processor being configured to set the threshold value to zero.

19. The system of claim 12 wherein the rendered image data includes multiple levels corresponding to a number of ink drops stored in each image data memory location; and
the processor is further configured to modify an ordered sequence search for each level in response to an edge being detected proximate to the defective inkjet image data memory location.

20. The system of claim 19 wherein the ordered sequence search for each level in an image data memory location is different for each level.

21. A computer readable medium containing instructions that, when executed by a computer, cause the computer to perform a method for detecting one or more edges in image data values stored in image data memory locations, and for modifying an ordered sequence search used to identify at least one image data memory location for storage of an image data compensation value in response to an edge being detected proximate to a defective inkjet image data memory location.

22. The computer readable medium of claim 20 containing instructions that also cause the computer to modify an ordered sequence search for each level stored in the defective inkjet image data memory location.

23. The computer readable medium of claim 20 further containing instructions that cause the computer to detect edges in binary image data derived from the image data values.
